(19) United States
(12) Patent Application Publication
(10) Pub. No.: US 2024/0403611 A1
(43) Pub. Date: Dec. 5, 2024

(54) ARTIFICIAL INTELLIGENCE RECOMMENDATIONS FOR MATCHING CONTENT OF ONE CONTENT TYPE WITH CONTENT OF ANOTHER

(71) Applicant: Microsoft Technology Licensing, LLC, Redmond, WA (US)

(72) Inventors: Athul Sudhakumar, Bayonne, NJ (US); Arjun K. Kulothungun, San Francisco, CA (US); Sneha Chaudhari, San Jose, CA (US); Shuzhe Xiao, Bellevue, WA (US); Hao Tong, Jersey City, NJ (US); Christopher Langbort, Brooklyn, NY (US); Miro Furtado, San Francisco, CA (US)

(21) Appl. No.: 18/216,365

(22) Filed: Jun. 29, 2023

Related U.S. Application Data
(60) Provisional application No. 63/469,703, filed on May 30, 2023.
(60) Provisional application No. 63/470,591, filed on Jun. 2, 2023.

(51) Int. Cl. G06N 3/0475

(52) U.S. Cl. CPC G06N 3/0475

(57) ABSTRACT

In an example embodiment, content understanding/embeddings are obtained for content of multiple different content types, using a generative artificial intelligence (GAI) model, and then those content understanding/embeddings can be utilized to match content across content type. In such embodiments, the embeddings may be used as input to a separately trained machine learning model that is designed to provide a similarity score between two different pieces of content, even when those two different pieces are of two different content types.

### CROSS-REFERENCE TO RELATED APPLICATIONS

This application claims priority to U.S. Provisional Application No. 63/470,591, filed Jun. 2, 2023, entitled “GENERATIVE ARTIFICIAL INTELLIGENCE FOR EMBEDDINGS USED AS INPUTS TO MACHINE LEARNING MODELS,” and U.S. Provisional Application No. 63/469,703, filed May 30, 2023, entitled “ARTIFICIAL INTELLIGENCE RECOMMENDATIONS FOR MATCHING CONTENT OF ONE CONTENT TYPE WITH CONTENT OF ANOTHER,” both of which are incorporated herein by reference in its entirety.

### TECHNICAL FIELD

The present disclosure generally relates to technical problems encountered in machine learning. More specifically, the present disclosure relates to the use of artificial intelligence recommendations for matching content of one content type with content of another.

### BACKGROUND

The rise of the Internet has occasioned two disparate yet related phenomena: the increase in the presence of online networks, such as social networking services, with their corresponding user profiles and posts visible to large numbers of people; and the increase in the use of such online networks for various forms of communications.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiment.

FIG. 3 is a block diagram illustrating the application server module of FIG. 1 in more detail, in accordance with another example embodiment.

FIG. 4 is a block diagram illustrating the application server module of FIG. 1 in more detail, in accordance with another example embodiment.

FIG. 5 is a block diagram illustrating a system including the application server module of FIG. 1 in more detail, in accordance with another example embodiment.

FIG. 6 is a flow diagram illustrating a method, in accordance with an example embodiment.

FIG. 7 is a screen capture illustrating a user interface, in accordance with an example embodiment.

FIG. 8 is a screen capture illustrating another user interface, in accordance with an example embodiment.

FIG. 9 is a screen capture illustrating a user interface, in accordance with an example embodiment.

FIG. 10 is a screen capture illustrating another user interface, in accordance with an example embodiment.

FIG. 11 is a block diagram illustrating a software architecture, in accordance with an example embodiment.

FIG. 12 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, the content understanding/embeddings are obtained for content of multiple different content types, and then those content understanding/embeddings can be utilized to match content across content type. In such embodiments, the embeddings may be used as input to a separately trained machine learning model that is designed to provide a similarity score between two different pieces of content, even when those two different pieces are of two different content types.

### Description

In various types of computer systems, machine learning algorithms are used to train and utilize machine learning models to recommend content. Often these machine learning models are trained to output calculations or scores based on a number of input features, with the importance of the input features being weighted based on coefficients learned during the training process. The content being recommended typically involves matching the content to particular users (e.g., recommending content to a user based on user profile information, or past interaction history), matching content to users based on specific user input (e.g., finding content most relevant to a search query), or matching content to similar content of the same content type (e.g., recommending an image that is a close match to an image input or selected by a user).

Creating content that will be relevant to a user or group of users can be challenging. This is especially true of advertising content, which will often be ignored by users unless it is appealing or fresh enough to garner interest. In an example embodiment, a Generative Artificial Intelligence (GAI) is used to automatically generate content based on insights, such as marketer-provided objectives, historical performance of prior advertising content, and/or information inferred from prior advertisements or portions of advertisements themselves.

GAI refers to a class of artificial intelligence techniques that involves training models to generate new, original data rather than simply making predictions based on existing data. These models learn the underlying patterns and structures in a given dataset and can generate new samples that are similar to the original data.

Some common examples of GAI models include Generative Adversarial Networks (GANs), Variational Autoencoders (VAEs), and autoregressive models. These models have been used in a variety of applications such as image and speech synthesis, music composition, and the creation of virtual environments and characters.

Additionally, in some instances, it may be beneficial to match content of one content type to content of another separate content type. This can be technically challenging as often the content types themselves are so different that features of the content cannot easily be matched. For example, an image is a series of pixels in various different colors, while textual content is a series of words. It is one thing to identify an image that matches another image by looking for similar pixel combinations, or identifying text that matches other text by looking for similar words or sentences. It is quite another to match an image to text or vice versa. Doing so requires a deeper understanding of the meaning of the content. For example, in order to know to match an image of a baseball player to a text article about baseball, the system would need to know that the series of pixels of various colors actually represents a baseball player. This can be technically challenging.

One particular area in which this problem may arise in an online network is in the case of advertising campaigns. In such campaigns, companies may run ads for products that include both text and image portions, or text and video portions. One could even consider the audio and visual portions of a video to be separate content types if the audio, such as voiceover narration or comments, is separable and has the potential to be used with multiple different visual portions. Traditionally it was common for advertisements with multiple content types combined to be created one at a time. Modern machine learning systems offer the possibility of freeing up the design time to allow for only one content type to be created or selected, with the machine learning system selecting or even automatically creating an appropriate matching piece of content of another content type. This, however, is technically challenging.

In an example embodiment, a machine learning model is introduced that allows for the automatic recommendation of content of a first content type that matches content of a second content type.

It should be noted that while advertising is mentioned as a possible use case for the various techniques described herein, there is nothing about the techniques that is itself related to advertising, and in fact the same techniques are robust enough to be used with many different types of content, across many different domains and use cases.

In some embodiments, GAI may be used to aid in understanding the meaning of content, across content types, to make the matching more effective when matching content of a first content type to content of a second content type, especially when those content types are very different (such as text versus images).

When a GAI model generates new, original data, it goes through the process of evaluating and classifying the data input to it. In an example embodiment, the product of this evaluation and classification is utilized to generate embeddings for data, rather than using the output of the generative AI model directly. Thus, for example, passing a user profile from an online network to a GAI model might ordinarily result in the GAI model creating a new, original user profile that is similar to the user profile passed to it. In an example embodiment, however, the new, original user profile is either not generated, or simply discarded. Rather, an embedding for the user profile is generated based on the intermediate work product of the GAI model that it would produce when going through the motions of generating the new, original user profile.

More particularly, the GAI model is used to generate content understanding in the form of the embeddings, rather than (or in addition to) generating content itself.

In an example embodiment, the content understanding/embeddings are obtained for content of multiple different content types, and then those content understanding/embeddings can be utilized to match content across content type. In such embodiments, the embeddings may be used as input to a separately trained machine learning model that is designed to provide a similarity score between two different pieces of content, even when those two different pieces are of two different content types.

In another example embodiment, a system is provided that combines the above two described solutions. Specifically, rather than merely recommending content of a first type that matches content of a second type, a GAI model can be used to generate the content of the first type, the content of the second type, or both, and then that generated content may be fed back into the GAI model (or, optionally, a different GAI model) to generate embeddings for the different pieces of content.

In some example embodiments, the GAI model may be a multi-modal model, in that it can generate data of multiple different types (e.g., text and image, text and video, etc.).

In an example embodiment, the GAI model is implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a GAN embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, as we discussed in the previous section, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code.

In either case, the GAI model contains a generative classifier, which can be implemented as, for example, a naïve Bayes classifier. It is the output of this generative classifier that can be leveraged to obtain embeddings, which can then be used as input to a separately trained machine learning model.

The above generally describes the overall process as used during inference-time (e.g., when the machine learning model matches two pieces of content of different content types), but the same or similar process of content understanding/embedding can be performed during training as well. Specifically, for some training data used to train the machine learning model, the training data, such as sample content, may be fed into the GAI model to generate embeddings that provide content understanding for those pieces of sample content in the training data.

In some example embodiments, the GAI model is used to generate single dimension embeddings, as opposed to multidimensional embeddings. A single dimension embedding is essentially a single value that represents the content understanding. One specific way that the single dimension embedding can be represented is as a category. Thus, in these example embodiments, the GAI model generates a category for a particular input piece of content. The categories may either be obtained by the GAI model from a fixed set of categories, or the categories may be supplied to the GAI model when the GAI model is generating the embedding (e.g., at the same time the piece of content is fed into the GAI model to be categorized).

In some example embodiments, the GAI model itself generates its own categories. In this case, the query to the GAI model may be something broad, such as “what is this piece of content about,” which allows the GAI model to generate a free-form description of the piece of content without being restricted to particular categories.

In some example embodiments, the GAI model is prompted to generate an embedding for a piece of content by accompanying the piece of content with a text question when it is fed to the GAI model. For example, the text question may be “what is the meaning of this?”.

The other advantage to using a GAI model for content understanding of content to be fed to another machine learning model is that the GAI model is robust enough to handle content from different domains. The various pieces of content may be in completely separate types of domains (e.g., one may be textual, another may be a video). Additionally, even when the pieces of content are in similar domains (e.g., they are both textual), their formatting could be completely different (e.g., a news article is generally longer and uses a different writing style than a user posting an update about a job promotion they have received). The GAI model is able to handle content of different domains and actually share some of its understanding across those domains (e.g., feedback it has received about a user post about a recent court decision can influence its understanding about a new article about the court decision, or other court decisions).

As mentioned earlier, the embeddings generated by the GAI model can then be used as input to the separately trained machine learning model. This separately trained machine learning model may be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the machine learning algorithm used to train the machine learning model may iterate among various weights (which are the parameters) that will be multiplied by various input variables (such as features of the pieces of content like embeddings) and evaluate a loss function at each iteration, until the loss function is minimized, at which stage the weights/parameters for that stage are learned. Specifically, the weights (e.g., values between 0 and 1) are multiplied by the input variables as part of a weighted sum operation, and the weighted sum operation is used by the loss function.

In some example embodiments, the training of the machine learning model may take place as a dedicated training phase. In other example embodiments, the machine learning model may be retrained dynamically at runtime by the user providing live feedback.

The machine learning model described above allows for both zero-shot and multi-shot content generation. Zero-shot learning is a machine learning approach that allows a model to recognize and classify objects or concepts it has never encountered during training. In traditional supervised learning, models are trained on a labelled dataset, where each instance is associated with a predefined set of classes. However, in zero-shot learning, the model can generalize its understanding to unseen classes by leveraging additional information.

Multi-shot learning, also known as multi-instance learning, is a machine learning paradigm that deals with problems where the training data consists of sets or bags of instances rather than individual instances. In multi-shot learning, each training example is a collection of instances, known as a bag, and the task is to classify the bags rather than the individual instances within them.

The key characteristic of multi-shot learning is that the labels or class assignments are provided at the bag level, meaning that the entire bag is assigned a single label. This differs from traditional supervised learning, where each instance is associated with a unique label.

In further example embodiments, the GAI model (or another GAI model) is used to generate a combined piece of content from multiple pieces of content of different content types. Thus, for example, if a first piece of content is matched with as second piece of content using the a machine learning model that takes as input embeddings for the first and second pieces of content as generated by a GAI model, then a GAI model may then also be used to determine how to combine the first and second pieces of content. There may be, for example, various types of visual parameters that can be selected when combining two pieces of content. One example would be the placement or ordering of the pieces of content. For example if one piece of content is text and the other piece of content is an image, in one combination the text may be superimposed on top of the image, while in another combination the text may appear above the image vertically. Oher example visual parameters include, for example, text size, text color, and text style. All of these visual parameters can be generated by the GAI model when generating the combined piece of content.

Furthermore, in some example embodiment, the GAI model that generates the combined piece of content can also generate additional content that is included in the combined piece of content, such as text (ad copy). In these example embodiments, various pieces of information may be used as input to the GAI model to help generate that additional content, such as company or product page information, advertising campaign targeting criteria, audience identifications, stated objective, or other text from documents of the company. In some instances, historical interaction information may also be used by the GAI model in the generation of the additional content (e.g., the GAI model may generate text that is closer to the text of prior successful campaigns than to the text of prior unsuccessful campaigns).

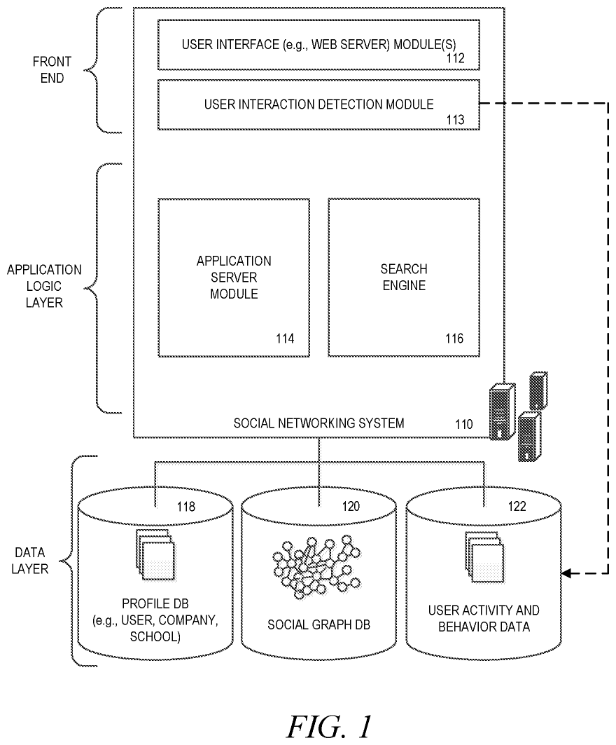

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based Application Program Interface (API) requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118 or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users' interactions and behavior (e.g., content viewed, links or buttons selected, messages responded to, etc.) may be tracked, and information concerning the users' activities and behavior may be logged or stored, for example, as indicated in FIG. 1, by the user activity and behavior database 122. This logged activity information may then be used by a search engine 116 to determine search results for a search query.

Additionally, in an example embodiment, the user interaction behavior is used generally to predict general engagement with the social networking service, as opposed to only predicting and optimizing for clicks on specific content. This allows the model to focus more on overall user experience than towards individual clicks (which generally involves modelling towards actions with monetization values). This, for example, allows for models that predict overall engagement with the social networking service, regardless of whether the engagement specifically results in immediate monetization value. This is in contrast to past models that would model specifically towards actions that include immediate monetization value (such as optimizing for number of clicks on sponsored content while not even trying to optimize for number of clicks on organic content).

Although not shown, in some embodiments, a social networking system 110 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

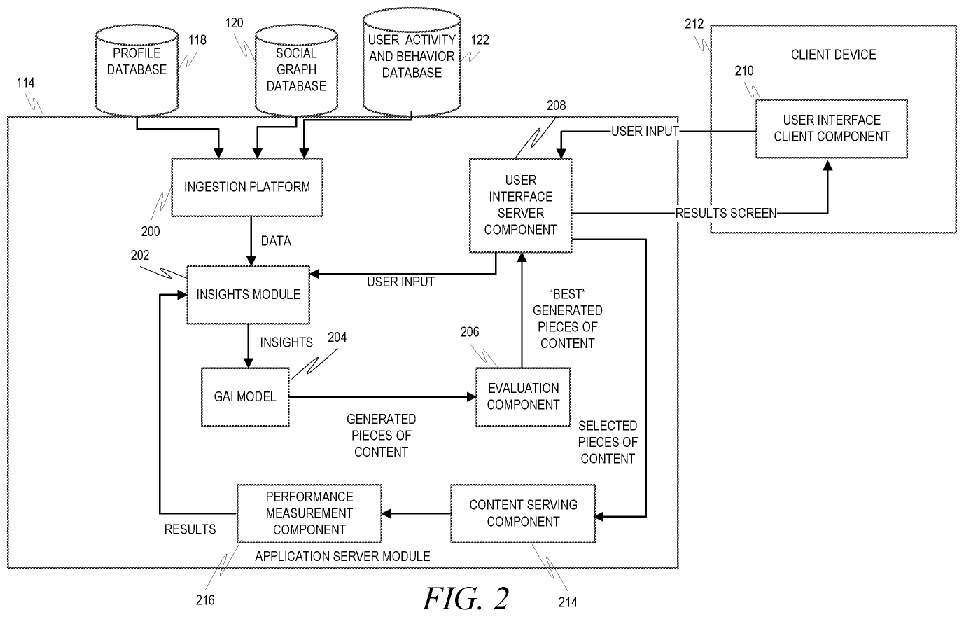

FIG. 2 is a block diagram illustrating the application server module 114 of FIG. 1 in more detail, in accordance with an example embodiment. While in many embodiments the application server module 114 will contain many subcomponents used to perform various actions within the social networking system 110, only those components that are relevant to the present disclosure are depicted in FIG. 2.

Here, an ingestion platform 200 obtains information from the profile database 118, the social graph database 120 and/or the user activity and behavior database 122, as well as obtaining information about content items relevant to an insights model 202. Notably, this information may be obtained from various different domains. “Domains” in this context does not necessarily refer to Internet domains (e.g., different domain names) but rather refers to different portions (e.g., surfaces, or sub-services) of a social networking service. For example, one domain may be advertisements while another domain may be job listings. The insights module 202 generates one or more insights based on the data from the ingestion platform. Insights in this context refer to any information relevant to generating pieces of content for display. The insights may be in textual or graphical form. In some instances, the insights may be explicitly provided by a user, such as a marketer, who may have explicitly provided a stated objective for an advertising campaign. In other instances, the insights may be inferred from historical interaction information, such as performance metrics of prior successful advertising campaigns. In yet other instances, the insights may be inferred from other content, such as summaries or deduced meanings of the other content. In yet other instances, the insights may be inferred from information obtained from a publicly available resource, such as current events and geographical and industry preferences.

The insights module 202 sends these one or more insights to a GAI model 204, which generates new content. This may be accomplished using the aforementioned insights, such as historical interaction information (or other statistical insights), an objective specified by an entity (e.g., marketer) for whom a piece of content (e.g., an advertisement) will be generated, one or more documents of the entity (e.g., a company web page, product web pages, in-app documents), etc.

Additionally, the GAI model 204 may generate one or more visual parameters for each combined piece of content. These visual parameters may include, for example, content placement or ordering, text color, text style, text length, and text size.

The result is that the GAI model 204 may generate one or more pieces of content using various different visual parameters.

In some embodiments, the GAI model 204 may generate one or more pieces of content (e.g., text, image, etc.) according to a desired tone. For example, the GAI model 204 may generate content having a specific tone (e.g., persuasive, informative, enthusiastic, professional, casual, funny, etc.) based on one or more of the objective and/or the aforementioned insights. In some embodiments, one or more pieces of content may be combined. An evaluation component 206 may then evaluate these generated pieces of content and output the “best” generated pieces of content. “Best” in this context loosely refers to a subset of the generated pieces of content that the evaluation component has decided are good enough, based on some metric or evaluation criteria, to be displayed to a user. This may include, for example, scoring each generated piece of content using some formula or model, and either ranking the generated pieces of content based on their scores (identifying the top n as the “best”, with n being a preset integer) or comparing the scores to a threshold which, if transgressed, means that the corresponding piece of content is “good enough” to be considered one of the “best”.

A user interface server component 208 communicates with a user interface client component 210 located on a client device 212 to use the “best” generated pieces of content to display or update the graphical user interface displayed to a user. This may be performed in response to a user input, such as a navigation input to a web page that includes an area to display content items to be selected for an advertisement campaign. For example, a user could instruct the user interface client component 210 to log into a social networking service account. This log-in information could then be sent to the user interface server component 208, which can use this information to instruct the ingestion platform 200 to retrieve the appropriate information from the profile database 118, the social graph database 120, and/or the user activity and behavior database 122.

In some example embodiments, a user, such as a marketer, uses the user interface client component 210 to select one or more of the presented generated pieces of content to serve to other users (such as in an advertising campaign). These selections may then be fed back into the insights module 202 as feedback for future iterations of the GAI model 204.

The selected pieces of content may then be also sent to a content serving component 214 which may then cause those pieces of content to be displayed. A performance measurement component 216 may then measure one or more metrics related to performance of those generated pieces of content, such as click-through-rate, number of conversions, etc. These performance results may then be fed back into the insights module 202 to be used as insights for future iterations of the GAI model 204.

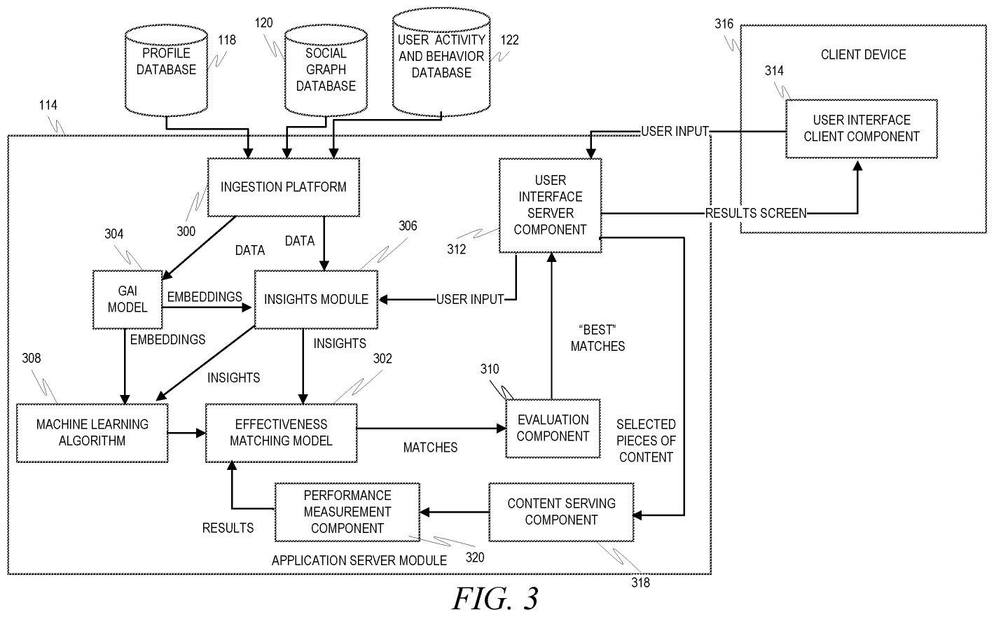

FIG. 3 is a block diagram illustrating the application server module 114 of FIG. 1 in more detail, in accordance with another example embodiment. While in many embodiments the application server module 114 will contain many subcomponents used to perform various actions within the social networking system 110, only those components that are relevant to the present disclosure are depicted in FIG. 3.

Here, an ingestion platform 300 obtains information from the profile database 118, the social graph database 120 and/or the user activity and behavior database 122, as well as obtaining information about content items relevant to an effectiveness matching model 302. In some embodiments, the ingestion platform 300 may be configured to obtain information from an external data source (e.g., a company web page, product web pages, in-app documents). At training time, this information may represent training data, and thus may be considered to be “sample data”. Notably, this training data may be obtained from various different domains. “Domains” in this context does not necessarily refer to Internet domains (e.g., different domain names) but rather refers to different portions (e.g., surfaces, or sub-services) of a social networking service. For example, one domain may be advertisements while another domain may be job listings. The ingestion platform 300 sends some of this information to a GAI model 304, which outputs an embedding indicative of the underlying meaning of each of the content items. Notably, this embedding is able to be produced by the GAI model 304 no matter what domains the training data are extracted from. This embedding may then be associated with the other training data. In some example embodiments, the training data may then be labelled using performance data. This performance data may include, for example, for a particular piece of content, information about how that piece of content performed when previously displayed. For example, if the piece of content is an advertisement or part of an advertisement (e.g., the text portion of an advertisement that contained text and an image), the information about how that piece of content performed when previously displayed may be information about how that advertisement performed (e.g., click rate, conversion rate, etc.) in prior advertisement campaigns. The label therefore reflects the effectiveness of the piece of content. In some example embodiments, this performance information may be broken up into multiple pieces of performance information based on format. For example, there may be one metric for click-through-rate for a piece of text when displayed alone and another metric for click-through-rate for the piece of text when displayed with, or combined with, an image.

The ingestion platform 300 also passes data to insights module 306. The insights module 302 generates one or more insights based on the data from the ingestion platform. Insights in this context refer to any information relevant to generating pieces of content for display. The insights may be in textual or graphical form. In some instances, the insights may be explicitly provided by a user, such as a marketer, who may have explicitly provided a stated objective for an advertising campaign. In other instances, the insights may be inferred from historical interaction information, such as performance metrics of prior successful advertising campaigns. In yet other instances, the insights may be inferred from other content, such as summaries or deduced meanings of the other content, such as the embeddings generated by the GAI model 304.

The embeddings and the insights may collectively be considered to be training data. All of the training data may be fed to a machine learning algorithm 308 that trains the effectiveness matching model 302.

At inference time, such as when a social networking service needs to determine which content items to match with each other, even when the content items are of different types (e.g., text vs. image), the ingestion platform 300 sends information corresponding to each considered content item to the GAI model 304 to obtain an embedding of each. Each of these embeddings can then be fed along with the information about the particular user (e.g., advertiser) and potentially other information about the considered content items to the insights module 306, which generates insights to the effectiveness matching model 302, which outputs an effectiveness matching score indicative of the effectiveness of a match of the first piece of content with the second piece of content with respect to a first metric (e.g., click through rate, conversion rate). The effectiveness matching model may use not only the embeddings of each of the pieces of content, but also other factors such as historical interaction information (or other statistical insights), an objective specified by an entity (e.g., marketer) for whom a combined piece of content (e.g., an advertisement) will be generated, one or more documents of the entity (e.g., a company web page, product web pages, in-app documents), etc. It may also use other features of the pieces of content, such as text and/or image size, colors, fonts, etc. as part of this matching process.

The effectiveness matching scores may be utilized by an evaluation component 310 to determine which pieces of content “best” match with which other pieces of content. This may be performed in a number of different ways. In an example embodiment, the effectiveness matching score of each potential match is compared to a predetermined threshold, and any potential match whose effectiveness matching score meets or transgresses the threshold will be considered a match. For example, if the effectiveness matching score is a number between 0 and 1, with 1 being the highest, then a threshold may be set at 0.8 and any potential match having an effectiveness matching score that meets or exceeds 0.8 will be considered a match. In another example embodiment, a predetermined number of matches will be selected based on the highest effectiveness matching score. For example, the 10 potential matches having the highest effectiveness matching scores will be selected as matches, no matter the raw score. Embodiments are also possible where combinations of these techniques are utilized.

A user interface server component 312 communicates with a user interface client component 314 located on a client device 316 to run the effectiveness matching model 302 and use its results to display or update the graphical user interface displayed to a user. This may be performed in response to a user input, such as a navigation input to a web page that includes an area to display content items to be selected for an advertisement campaign. For example, a user could instruct the user interface client component 314 to log into a social networking service account. This log-in information could then be sent to the user interface server component 312, which can use this information to instruct the ingestion platform 300 to retrieve the appropriate information from the profile database 118, the social graph database 120, and/or the user activity and behavior database 122.

In some example embodiments, a user, such as a marketer, uses the user interface client component 314 to select one or more of the presented generated pieces of content to serve to other users (such as in an advertising campaign). These selections may then be fed back into the insights module 306 as feedback for future iterations of the effectiveness matching model 302.

The selected pieces of content may then be also sent to a content serving component 318 which may then cause those pieces of content to be displayed. A performance measurement component 320 may then measure one or more metrics related to performance of those generated pieces of content, such as click-through-rate, number of conversions, etc. These performance results may then be fed back into the insights module 306 to be used as insights for future iterations of the effectiveness matching model 302.

In an example embodiment, the machine learning algorithm 308 used to train the effectiveness matching machine learning model 302 may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the machine learning model may take place as a dedicated training phase. In other example embodiments, the machine learning model may be retrained dynamically at runtime by the user providing live feedback.

Furthermore, in some example embodiments, the historical interaction information is utilized to provide feedback to the machine learning algorithm during the training (or retraining) of the machine learning model.

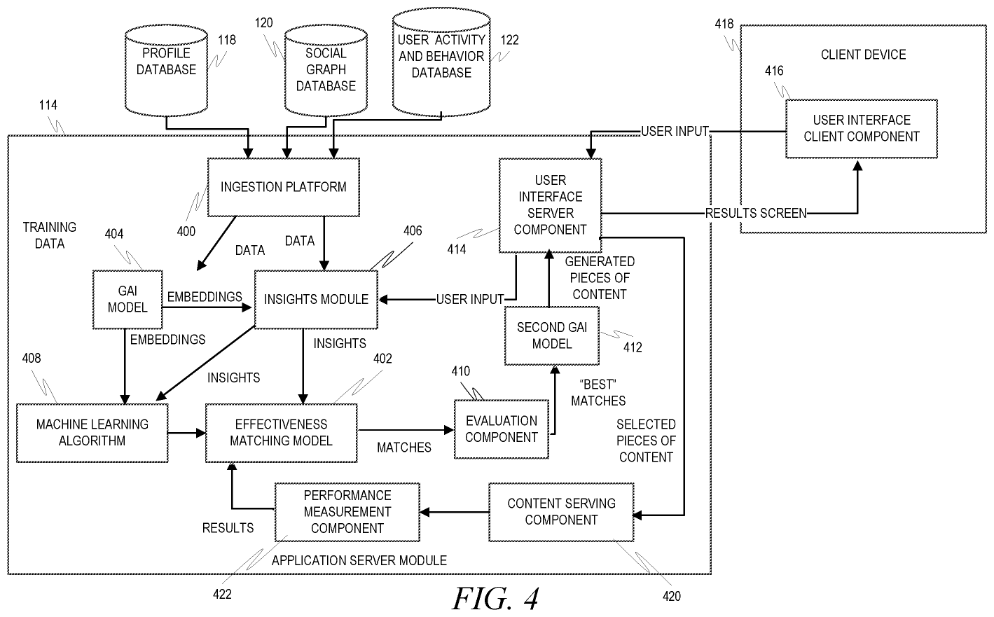

FIG. 4 is a block diagram illustrating the application server module 114 of FIG. 1 in more detail, in accordance with another example embodiment. While in many embodiments the application server module 114 will contain many subcomponents used to perform various actions within the social networking system 110, only those components that are relevant to the present disclosure are depicted in FIG. 4.

FIG. 4 essentially represents a combination of FIGS. 3 and 4.

Here, an ingestion platform 400 obtains information from the profile database 118, the social graph database 120 and/or the user activity and behavior database 122, as well as obtaining information about content items relevant to an effectiveness matching model 402. At training time, this information may represent training data, and thus may be considered to be “sample data”. Notably, this training data may be obtained from various different domains. “Domains” in this context does not necessarily refer to Internet domains (e.g., different domain names) but rather refers to different portions (e.g., surfaces, or sub-services) of a social networking service. For example, one domain may be advertisements while another domain may be job listings. The ingestion platform 400 sends some of this information to a first GAI model 404, which outputs an embedding indicative of the underlying meaning of each of the content items. Notably, this embedding is able to be produced by the first GAI model 404 no matter what domains the training data are extracted from. This embedding may then be associated with the other training data. In some example embodiments, the training data may then be labelled using performance data. This performance data may include, for example, for a particular piece of content, information about how that piece of content performed when previously displayed. For example, if the piece of content is an advertisement or part of an advertisement (e.g., the text portion of an advertisement that contained text and an image), the information about how that piece of content performed when previously displayed may be information about how that advertisement performed (e.g., click rate, conversion rate, etc.) in prior advertisement campaigns. The label therefore reflects the effectiveness of the piece of content. In some example embodiments, this performance information may be broken up into multiple pieces of performance information based on format. For example, there may be one metric for click-through-rate for a piece of text when displayed alone and another metric for click-through-rate for the piece of text when displayed with, or combined with, an image.

The ingestion platform 400 also passes data to insights module 406. The insights module 406 generates one or more insights based on the data from the ingestion platform. Insights in this context refer to any information relevant to generating pieces of content for display. The insights may be in textual or graphical form. In some instances, the insights may be explicitly provided by a user, such as a marketer, who may have explicitly provided a stated objective for an advertising campaign. In other instances, the insights may be inferred from historical interaction information, such as performance metrics of prior successful advertising campaigns. In yet other instances, the insights may be inferred from other content, such as summaries or deduced meanings of the other content, such as the embeddings generated by the first GAI model 404.

The embeddings and the insights may collectively be considered to be training data. All of the training data may be fed to a machine learning algorithm 408 that trains the effectiveness matching model 402.

At inference time, such as when a social networking service needs to determine which content items to match with each other, even when the content items are of different types (e.g., text vs. image), the ingestion platform 400 sends information corresponding to each considered content item to the first GAI model 404 to obtain an embedding of each. Each of these embeddings can then be fed along with the information about the particular user (e.g., advertiser) and potentially other information about the considered content items to the insights module 406, which generates insights to the effectiveness matching model 402, which outputs an effectiveness matching score indicative of the effectiveness of a match of the first piece of content with the second piece of content with respect to a first metric (e.g., click through rate, conversion rate). The effectiveness matching model may use not only the embeddings of each of the pieces of content, but also other factors such as historical interaction information (or other statistical insights), an objective specified by an entity (e.g., marketer) for whom a combined piece of content (e.g., an advertisement) will be generated, one or more documents of the entity (e.g., a company web page, product web pages, in-app documents), etc.

The effectiveness matching scores may be utilized by an evaluation component 410 to determine which pieces of content “best” match with which other pieces of content. This may be performed in a number of different ways. In an example embodiment, the effectiveness matching score of each potential match is compared to a predetermined threshold, and any potential match whose effectiveness matching score meets or transgresses the threshold will be considered a match. For example, if the effectiveness matching score is a number between 0 and 1, with 1 being the highest, then a threshold may be set at 0.8 and any potential match having an effectiveness matching score that meets or exceeds 0.8 will be considered a match. In another example embodiment, a predetermined number of matches will be selected based on the highest effectiveness matching score. For example, the 10 potential matches having the highest effectiveness matching scores will be selected as matches, no matter the raw score. Embodiments are also possible where combinations of these techniques are utilized.

The results from the evaluation component 410 (which may include not just the fact that, for example, two pieces of content were matched, but features of the matched pieces of content themselves, such as text and/or image size, color, font style etc.) could then be sent to a second GAI model 412, which then generates at least one combined piece of content for each of the matches. The second GAI model 412 may combine the features of the matching pieces of content in various ways using various different user interface server component 208, which, along with the user interface client component 210, could select and format appropriate content for display to the user.

In some example embodiments, the second GAI model 412 additionally creates new content (e.g., new text) to be included in the combined piece of content (along with the features of the matching pieces of content). This may be accomplished using the aforementioned historical interaction information (or other statistical insights), an objective specified by an entity (e.g., marketer) for whom a combined piece of content (e.g., an advertisement) will be generated, one or more documents of the entity (e.g., a company web page, product web pages, in-app documents), etc.

Additionally, the second GAI model 412 may generate one or more visual parameters for each combined piece of content. These visual parameters may include, for example, content placement or ordering, text color, text style, and text size.

The result is that the second GAI model 412 may generate one or more combined piece of content for each of the “best” matching pieces of content, and of course there may be multiple matching pieces of content as well. Thus, for example, if a first piece of content is considered a match for both a second piece of content and a fourth piece of content, the second GAI model 412 may be used to generate various combinations of the first and second piece of content using various different visual parameters, and then also to generate various combinations of the first and fourth piece of content using various different visual parameters.

It should also be noted that in some example embodiments the first GAI model 404 and the second GAI model 412 are the same model.

A user interface server component 414 communicates with a user interface client component 416 located on a client device 418 to run the effectiveness matching model 402 and use its results to display or update the graphical user interface displayed to a user. This may be performed in response to a user input, such as a navigation input to a web page that includes an area to display content items to be selected for an advertisement campaign. For example, a user could instruct the user interface client component 416 to log into a social networking service account. This log-in information could then be sent to the user interface server component 414, which can use this information to instruct the ingestion platform 400 to retrieve the appropriate information from the profile database 118, the social graph database 120, and/or the user activity and behavior database 122.

In some example embodiments, a user, such as a marketer, uses the user interface client component 416 to select one or more of the presented generated pieces of content to serve to other users (such as in an advertising campaign). These selections may then be fed back into the insights module 406 as feedback for future iterations of the effectiveness matching model 402.

The selected pieces of content may then be also sent to a content serving component 420 which may then cause those pieces of content to be displayed. A performance measurement component 422 may then measure one or more metrics related to performance of those generated pieces of content, such as click-through-rate, number of conversions, etc. These performance results may then be fed back into the insights module 406 to be used as insights for future iterations of the effectiveness matching model 402.

In an example embodiment, the machine learning algorithm 408 used to train the effectiveness matching machine learning model 402 may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the machine learning model may take place as a dedicated training phase. In other example embodiments, the machine learning model may be retrained dynamically at runtime by the user providing live feedback.

Furthermore, in some example embodiments, the historical interaction information is utilized to provide feedback to the machine learning algorithm during the training (or retraining) of the machine learning model.

It should be noted that while FIGS. 2-4 each depict various components executing on an application server module, some of these components may, in some example embodiments, be located on a client device rather than an application server module 114, such as client device 212 of FIG. 2, client device 316 of FIG. 3, client device 418 of FIG. 4. For example, one or more GAI models may be located on a client device to either generate embeddings used for analysis or generate content itself. Likewise, the effectiveness matching model 302 of FIG. 3 and effectiveness matching model 402 of FIG. 2 could be moved to corresponding client devices 316 and 418 to perform the matching aspects described herein on a client device rather than on a server.

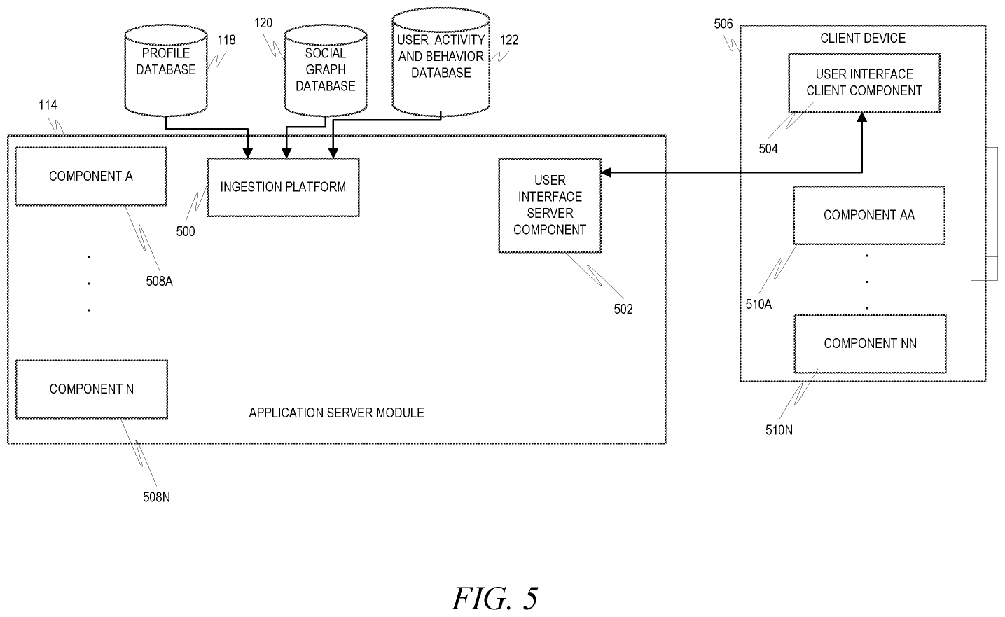

FIG. 5 is a block diagram illustrating a system including the application server module 114 of FIG. 1 in more detail, in accordance with another example embodiment. While in many embodiments the application server module 114 will contain many subcomponents used to perform various actions within the social networking system 110, only those components that are relevant to the present disclosure are depicted in FIG. 4.

Here, an ingestion platform 500 obtains information from the profile database 118, the social graph database 120 and/or the user activity and behavior database 122. A user interface server component 502 also then interfaces with a user interface client component 504 on client device 506. Any of the components described above as being contained in application server module 114 of FIG. 4 above can then be included on either the application server module 114 or the client device 506 in FIG. 5, as components A-N (508A-508N) or components AA-NN (510A-510N).

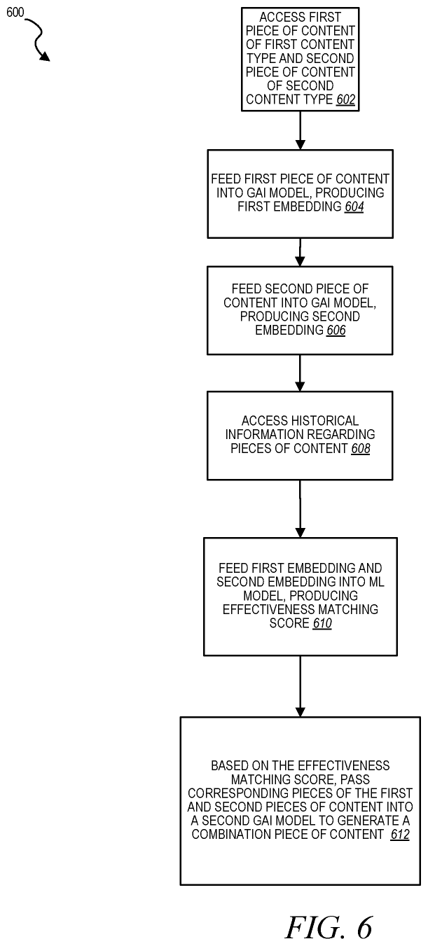

FIG. 6 is a flow diagram illustrating a method 600, in accordance with an example embodiment. At operation 602, a first piece of content of a first content type and a second piece of content of a second content type are accessed. In an example embodiment, not only are these pieces of content of different types, but they are also obtained from different domains. At operation 604, the first piece of content is fed into a generative artificial intelligence (GAI) model. The GAI model outputs a first embedding corresponding to the first piece of content, the first embedding being a representation of a meaning of the first piece of content. At operation 606, the second piece of content is fed into the GAI model. The GAI model outputs a second embedding corresponding to the second piece of content, the second embedding being a representation of a meaning of the second piece of content.

At operation 608, historical interaction information regarding pieces of content is accessed. This historical interaction information may include performance data indicating how well each piece of content performed during prior display (such as in a prior campaign), either alone or in combination with other pieces of content. This performance data may measure performance based upon one or more metrics, such as click through rate, conversion rate, etc. The historical interaction information can also be information regarding other pieces of content, such as pieces of content that may be similar to the first and second pieces of content.

At operation 610, the first embedding and the second embedding are fed into a machine learning model. The machine learning model outputs an effectiveness matching score indicative of effectiveness of matching one or more features of the first piece of content with one or more features the second piece of content with respect to a first metric based on the historical interaction information. The first metric may match at least one of the one or more metrics from the historical data. The matching may also be based on any one of a number of different features of the first and second pieces of content, such as text or image size, colors, and styles. Then, at operation 612, based on the effectiveness matching scores of the first piece of content and the second piece of content, the first and second pieces of content are passed into a second GAI model to generate a combination piece of content having one or more features, such as text size, text color, front style, and image size.

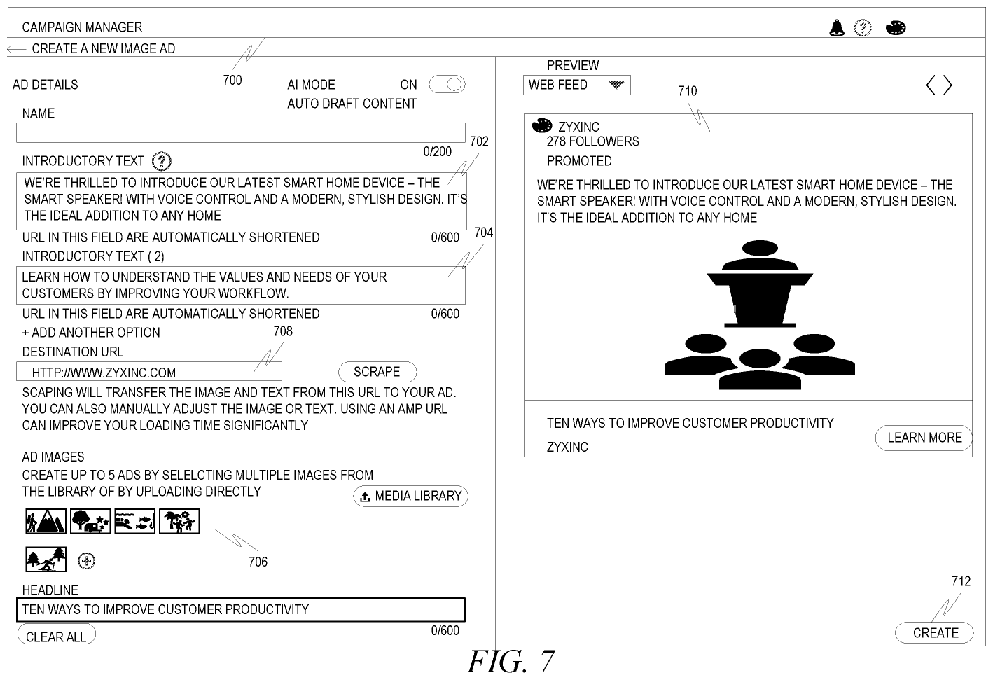

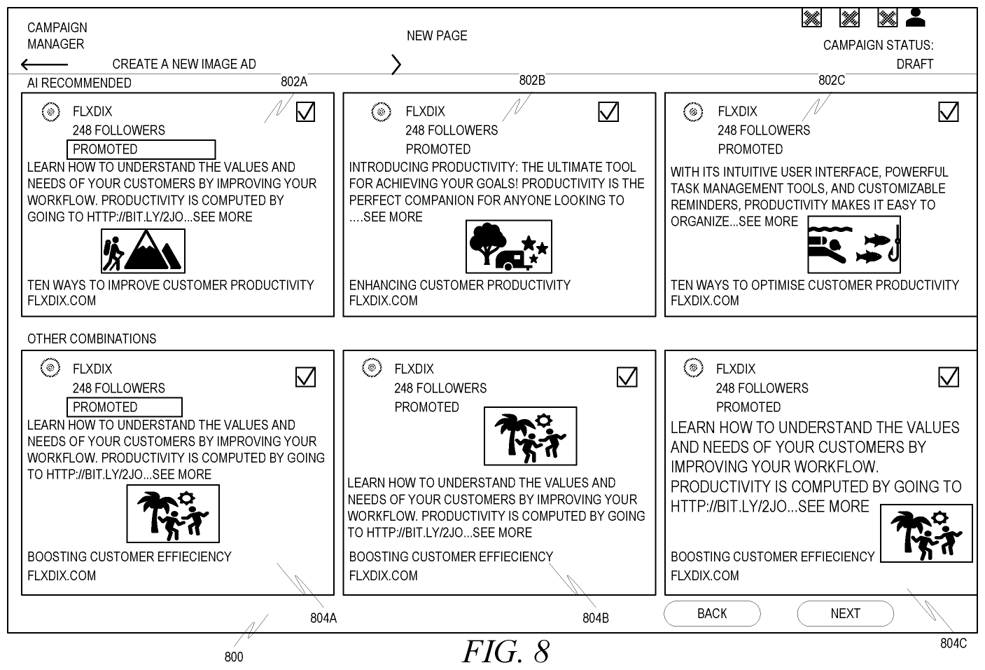

FIGS. 7 and 8 provide example screen captures showing the techniques described above to recommend content. This content may either be matched content or newly generated content using a GAI model. FIG. 7 is a screen capture illustrating a user interface 700, in accordance with an example embodiment. Here, the user interface 700 provides various fields related to an advertisement to be generated. A user may input text content in fields 702 and optionally field 704 and may additionally attach a plurality of images in ad image area 706, such as ones obtained from a media library of the user (e.g., a library of images used in past advertising campaigns for the user or an organization associated with the user). A uniform resource locator (URL) field 708 allows the user to specify a web address, as depicted here, which can then be accessed for additional content. This content may be previewed in section 710.

Once all the content has been accessed, the user may hit a create button 712, which may cause an associated system to recommend various combinations of the supplied content for a generated advertisement.

FIG. 8 is a screen capture illustrating a user interface 800, in accordance with an example embodiment. Here, a number of recommended generated advertisements 802A-802C are presented, as well as generated advertisements 804A-804C, which are not recommended but are still presented as other options for the user to select. The recommended generated advertisements 802A-802C are selected based on the processes described earlier, namely each supplied piece of content may be passed through a GAI model to create an embedding, and these embeddings, as well as historical interaction information, may be fed into a separately trained machine learning model to generate an effectiveness matching score for each of various combinations of the content. Combinations whose effectiveness matching scores exceed a predetermined threshold may then be selected as recommended generated advertisements 802A-802C.

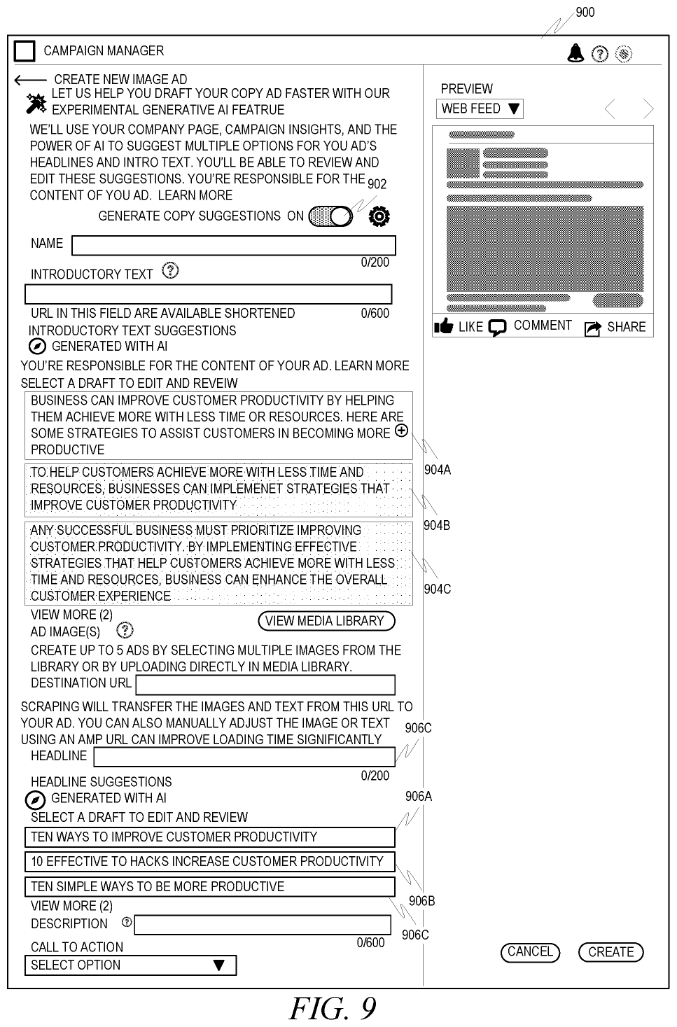

FIG. 9 is a screen capture illustrating a user interface 900, in accordance with an example embodiment. Here the user may select a toggle 902 indicating that the user wishes for the system, and specifically a GAI model, to generate copy suggestions. In response to this, the GAI model can generate preliminary text suggestions 904A, 904B, 904C and preliminary headline suggestions 906A, 906B, 906C.

The user can either select from the preliminary text suggestions 904A, 904B, 904C and preliminary headline suggestions 906A, 906B, 906C, or the system can automatically select from them, to generate a new combined piece of content.

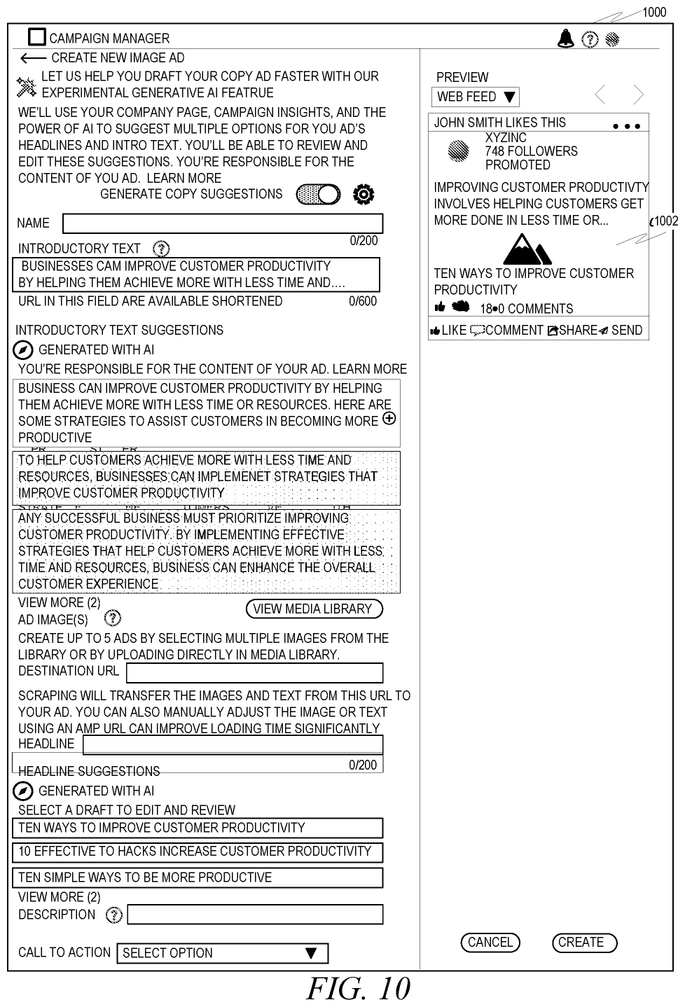

FIG. 10 is a screen capture illustrating a user interface 1000 in which a new combined piece of content 1002 has been generated. Here, the new combined piece of content 1002 was generated based on the selected one or more text suggestions 1004A, 1004B, 1004C and preliminary headline suggestions 1006A, 1006B, 1006C, as well as any provided images.

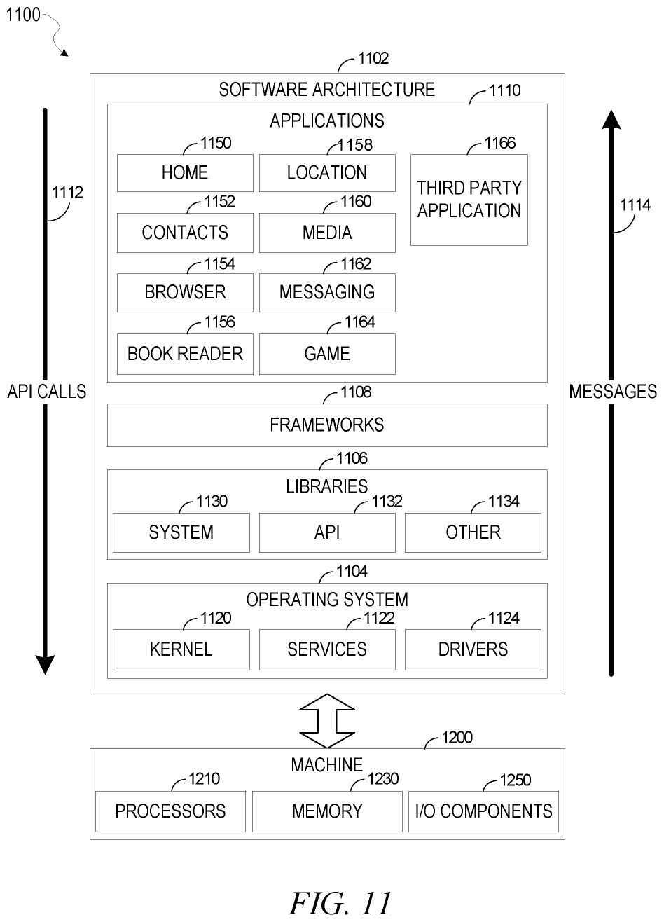

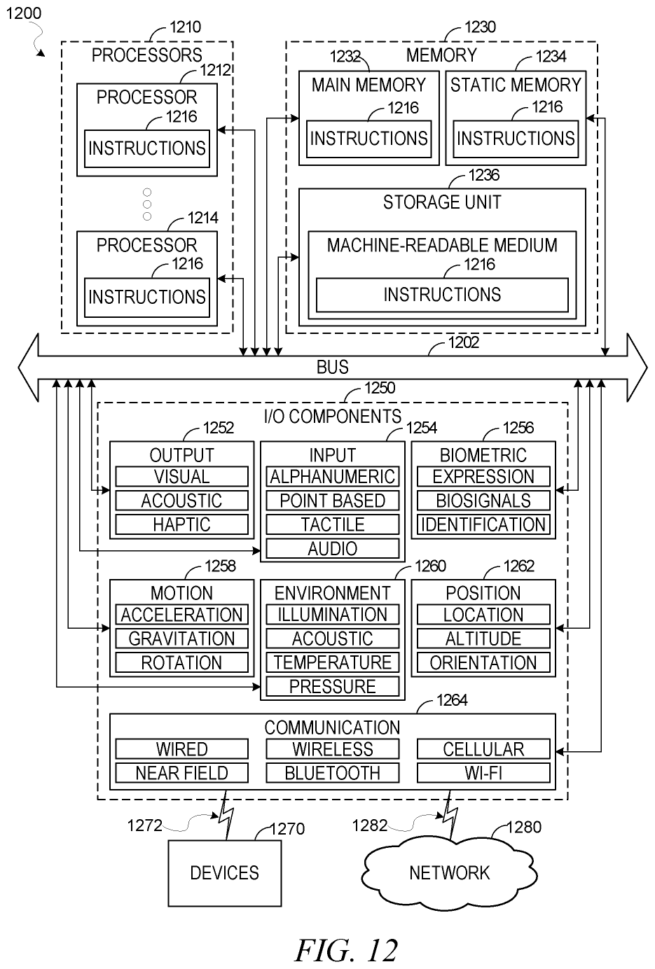

FIG. 11 is a block diagram 1100 illustrating a software architecture 1102, which can be installed on any one or more of the devices described above. FIG. 11 is merely a non-limiting example of a software architecture, and it will be appreciated that many other architectures can be implemented to facilitate the functionality described herein. In various embodiments, the software architecture 1102 is implemented by hardware such as a machine 1200 of FIG. 12 that includes processors 1210, memory 1230, and input/output (I/O) components 1250. In this example architecture, the software architecture 1102 can be conceptualized as a stack of layers where each layer may provide a particular functionality. For example, the software architecture 1102 includes layers such as an operating system 1104, libraries 1106, frameworks 1108, and applications 1110. Operationally, the applications 1110 invoke API calls 1112 through the software stack and receive messages 1114 in response to the API calls 1112, consistent with some embodiments.

In various implementations, the operating system 1104 manages hardware resources and provides common services. The operating system 1104 includes, for example, a kernel 1120, services 1122, and drivers 1124. The kernel 1120 acts as an abstraction layer between the hardware and the other software layers, consistent with some embodiments. For example, the kernel 1120 provides memory management, processor management (e.g., scheduling), component management, networking, and security settings, among other functionality. The services 1122 can provide other common services for the other software layers. The drivers 1124 are responsible for controlling or interfacing with the underlying hardware, according to some embodiments. For instance, the drivers 1124 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 1106 provide a low-level common infrastructure utilized by the applications 1110. The libraries 1106 can include system libraries 1130 (e.g., C standard library) that can provide functions such as memory allocation functions, string manipulation functions, mathematic functions, and the like. In addition, the libraries 1106 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1106 can also include a wide variety of other libraries 1134 to provide many other APIs to the applications 1110.

The frameworks 1108 provide a high-level common infrastructure that can be utilized by the applications 1110, according to some embodiments. For example, the frameworks 1108 provide various graphical user interface functions, high-level resource management, high-level location services, and so forth. The frameworks 1108 can provide a broad spectrum of other APIs that can be utilized by the applications 1110, some of which may be specific to a particular operating system 1104 or platform.

In an example embodiment, the applications 1110 include a home application 1150, a contacts application 1152, a browser application 1154, a book reader application 1156, a location application 1158, a media application 1160, a messaging application 1162, a game application 1164, and a broad assortment of other applications, such as a third-party application 1166. According to some embodiments, the applications 1110 are programs that execute functions defined in the programs. Various programming languages can be employed to create one or more of the applications 1110, structured in a variety of manners, such as object-oriented programming languages (e.g., Objective-C, Java, or C++) or procedural programming languages (e.g., C or assembly language). In a specific example, the third-party application 1166 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1166 can invoke the API calls 1112 provided by the operating system 1104 to facilitate functionality described herein.

FIG. 12 illustrates a diagrammatic representation of a machine 1200 in the form of a computer system within which a set of instructions may be executed for causing the machine 1200 to perform any one or more of the methodologies discussed herein, according to an example embodiment. Specifically, FIG. 12 shows a diagrammatic representation of the machine 1200 in the example form of a computer system, within which instructions 1216 (e.g., software, a program, an application 1110, an applet, an app, or other executable code) for causing the machine 1200 to perform any one or more of the methodologies discussed herein may be executed. For example, the instructions 1216 may cause the machine 1200 to execute the method 600 of FIG. 6. Additionally, or alternatively, the instructions 1216 may implement FIGS. 1-10, and so forth. The instructions 1216 transform the general, non-programmed machine 1200 into a particular machine 1200 programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by the machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210, memory 1230, and I/O components 1250, which may be configured to communicate with each other such as via a bus 1202. In an example embodiment, the processors 1210 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1212 and a processor 1214 that may execute the instructions 1216. The term “processor” is intended to include multi-core processors 1210 that may comprise two or more independent processors 1212 (sometimes referred to as “cores”) that may execute instructions 1216 contemporaneously. Although FIG. 12 shows multiple processors 1210, the machine 1200 may include a single processor 1212 with a single core, a single processor 1212 with multiple cores (e.g., a multi-core processor), multiple processors 1210 with a single core, multiple processors 1210 with multiple cores, or any combination thereof.

The memory 1230 may include a main memory 1232, a static memory 1234, and a storage unit 1236, all accessible to the processors 1210 such as via the bus 1202. The main memory 1232, the static memory 1234, and the storage unit 1236 store the instructions 1216 embodying any one or more of the methodologies or functions described herein. The instructions 1216 may also reside, completely or partially, within the main memory 1232, within the static memory 1234, within the storage unit 1236, within at least one of the processors 1210 (e.g., within the processor's cache memory), or any suitable combination thereof, during execution thereof by the machine 1200.

The I/O components 1250 may include a wide variety of components to receive input, provide output, produce output, transmit information, exchange information, capture measurements, and so on. The specific I/O components 1250 that are included in a particular machine 1200 will depend on the type of machine 1200. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion, and the grouping is in no way limiting. In various example embodiments, the I/O components 1250 may include output components 1252 and input components 1254. The output components 1252 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1250 may include biometric components 1256, motion components 1258, environmental components 1260, or position components 1262, among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1258 may include acceleration sensor components (e.g., accelerometer), gravitation sensor components, rotation sensor components (e.g., gyroscope), and so forth. The environmental components 1260 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1262 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via a coupling 1282 and a coupling 1272, respectively. For example, the communication components 1264 may include a network interface component or another suitable device to interface with the network 1280. In further examples, the communication components 1264 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a USB).

Moreover, the communication components 1264 may detect identifiers or include components operable to detect identifiers. For example, the communication components 1264 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 1230, 1232, 1234, and/or memory of the processor(s) 1210) and/or the storage unit 1236 may store one or more sets of instructions 1216 and data structures (e.g., software) embodying or utilized by any one or more of the methodologies or functions described herein. These instructions (e.g., the instructions 1216), when executed by the processor(s) 1210, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1216 and/or data. The terms shall accordingly be taken to include, but not be limited to, solid-state memories, and optical and magnetic media, including memory internal or external to the processors 1210. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1280 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1280 or a portion of the network 1280 may include a wireless or cellular network, and the coupling 1282 may be a Code Division Multiple Access (CDMA) connection, a Global System for Mobile communications (GSM) connection, or another type of cellular or wireless coupling. In this example, the coupling 1282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 1216 may be transmitted or received over the network 1280 using a transmission medium via a network interface device (e.g., a network interface component included in the communication components 1264) and utilizing any one of a number of well-known transfer protocols (e.g., HTTP). Similarly, the instructions 1216 may be transmitted or received using a transmission medium via the coupling 1272 (e.g., a peer-to-peer coupling) to the devices 1270. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1216 for execution by the machine 1200, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one processor; and
at least one non-transitory computer-readable medium having instructions stored thereon, which, when executed by the at least one processor, cause the system to perform operations comprising:
accessing a first piece of content of a first content type and a second piece of content of a second content type;
feeding the first piece of content into a first generative artificial intelligence (GAI) model, the first GAI model outputting a first embedding corresponding to the first piece of content, the first embedding being a representation of a meaning of the first piece of content;
feeding the second piece of content into the first GAI model, the first GAI model outputting a second embedding corresponding to the second piece of content, the second embedding being a representation of a meaning of the second piece of content;
accessing historical interaction information regarding pieces of content;
feeding the first embedding and the second embedding into a machine learning model, the machine learning model outputting an effectiveness matching score indicative of effectiveness of matching the first piece of content the second piece of content with respect to a first metric based on the historical interaction information; and
based on the effectiveness matching score of the first piece of content and the second piece of content, passing the first and second pieces of content into a second GAI model to generate a combination piece of content.

2. The system of claim 1, wherein the first GAI model and the second GAI model are an identical GAI model.

3. The system of claim 1, wherein the machine learning model is trained based on the historical interaction information.

4. The system of claim 1, wherein the operations further comprise:
causing the generated combination pieces of content to be displayed in a graphical user interface of a client device presenting a first online platform, for selection by a user.

5. The system of claim 1, wherein the first content type and the second content type are each a different one of an image, a text snippet, or a video.

6. The system of claim 1, wherein the operations further comprise: receiving a text-based objective, wherein the feeding includes feeding the text-based objective into the machine learning model and wherein the passing includes passing the text-based objective into the second GAI model.

7. The system of claim 1, wherein the operations further comprise: receiving an indication of desired audience, wherein the feeding includes feeding the indication of desired audience into the machine learning model and wherein the passing includes passing the indication of the desired audience into the second GAI model.

8. The system of claim 1, wherein the operations further comprise: accessing a document of an entity for which the combined of piece of content is being generated, wherein the feeding includes feeding data from the document into the machine learning model and wherein the passing includes passing the data from the document into the second GAI model.

9. The system of claim 4, wherein the machine learning model takes as input one or more features corresponding to the user.

10. The system of claim 1, wherein the second GAI model generates at least one of a text color, text style, or text size of the combination piece of content.

11. The system of claim 1, wherein the effectiveness matching score is at least partially based on a similarity between the first piece of content and the second piece of content as determined based on a comparison between the first embedding and the second embedding.

12. The system of claim 1, wherein the historical interaction information includes interaction information retrieved from multiple different domains of an online platform.

13. The system of claim 12, wherein the feeding the first piece of content includes feeding the first piece of content and a list of categories into the first GAI model, and the first embedding represents a selection of a category from the list of categories, the category determined by the first GAI model to be a closest match for the meaning of the content.

14. The system of claim 12, wherein the feeding the first piece of content includes additionally providing the first GAI model with a text question about the first piece of content.

15. The system of claim 1, wherein the machine learning model is trained offline using training data, the training data comprising prior pieces of content presented via an online platform that have been labeled with performance data regarding how the prior pieces of content were interacted with when presented via the online platform.

16. A method comprising:
accessing a first piece of content of a first content type and a second piece of content of a second content type;
feeding the first piece of content into a first generative artificial intelligence (GAI) model, the first GAI model outputting a first embedding corresponding to the first piece of content, the first embedding being a representation of a meaning of the first piece of content;
feeding the second piece of content into the first GAI model, the first GAI model outputting a second embedding corresponding to the second piece of content, the second embedding being a representation of a meaning of the second piece of content;
accessing historical interaction information regarding pieces of content;
feeding the first embedding and the second embedding into a machine learning model, the machine learning model outputting an effectiveness matching score indicative of effectiveness of matching the first piece of content the second piece of content with respect to a first metric based on the historical interaction information; and
based on the effectiveness matching score of the first piece of content and the second piece of content, passing the first and second pieces of content into a second GAI model to generate a combination piece of content.

17. The method of claim 16, further comprising:
causing the generated combination pieces of content to be displayed in a graphical user interface of a client device presenting a first online platform, for selection by a user.

18. The method of claim 16, wherein the first content type and the second content type are each a different one of an image, a text snippet, or a video.

19. A non-transitory machine-readable storage medium comprising instructions which, when implemented by one or more machines, cause the one or more machines to perform operations comprising:
accessing a first piece of content of a first content type and a second piece of accessing a first piece of content of a first content type and a second piece of content of a second content type;
feeding the first piece of content into a first generative artificial intelligence (GAI) model, the first GAI model outputting a first embedding corresponding to the first piece of content, the first embedding being a representation of a meaning of the first piece of content;
feeding the second piece of content into the first GAI model, the first GAI model outputting a second embedding corresponding to the second piece of content, the second embedding being a representation of a meaning of the second piece of content;
accessing historical interaction information regarding pieces of content;
feeding the first embedding and the second embedding into a machine learning model, the machine learning model outputting an effectiveness matching score indicative of effectiveness of matching the first piece of content the second piece of content with respect to a first metric based on the historical interaction information; and
based on the effectiveness matching score of the first piece of content and the second piece of content, passing the first and second pieces of content into a second GAI model to generate a combination piece of content.

20. The non-transitory machine-readable storage medium of claim 19, wherein the first GAI model and the second GAI model are an identical GAI model.
